(19) United States
(12) Patent Application Publication
(10) Pub. No.: US 2013/0019973 A1
(43) Pub. Date: Jan. 24, 2013

(54) COUPLING

(71) Applicants: Michael R. Gose, Waverly, MN (US); Timothy T. Marquis, Otsego, MN (US); Paul LeMay, Saint Paul, MN (US)

(72) Inventors: Michael R. Gose, Waverly, MN (US); Timothy T. Marquis, Otsego, MN (US); Paul LeMay, Saint Paul, MN (US)

(21) Appl. No.: 13/550,936

(22) Filed: Jul. 17, 2012

Related U.S. Application Data
(60) Provisional application No. 61/508,744, filed on Jul. 18, 2011.

(51) Int. Cl. F16L 37/00; F16L 37/28; F16L 37/23

(52) U.S. Cl. 137/798; 285/351; 285/390; 285/332.2

(57) ABSTRACT

A fluid coupling 10 includes a first coupling member 11 and a second coupling member 12. The coupling members 11 and 12 are longitudinally movable relative to one another between first through fifth configurations illustrated in FIGS. 1-5 during a connection and disconnection sequence. The coupling 10 uses a locking sleeve 68 and locking balls 67 to facilitate connection and disconnection without tools. The coupling member 11 includes O-ring seals 26 and 27 carried on a sealing portion 24, and the locking balls 67 are radially spaced from the seals 26 and 27 during the connection and disconnection sequence to eliminate seal damage during the sequence. The first coupling member 11 includes a valve mechanism 41, 42, 43 and a fluid filter 46, and the valve mechanism is retained in place by the fluid filter 46. Cooperating valve mechanism 41, 42, 43, 63, 64, 65 includes a self-aligning valve poppet 64.

### RELATED APPLICATION

This application claims priority of U.S. Provisional Application No. 61/508,744 filed on Jul. 18, 2011, which is hereby incorporated by reference in its entirety.

### TECHNICAL FIELD

This invention relates to couplings for fluid systems. More specifically, this invention relates to quick connect couplings for selectively connecting and disconnecting components in a fluid system.

### BACKGROUND OF THE INVENTION

Couplings are used in numerous applications to connect and disconnect components of a system. For example, fluid couplings are used to connect and disconnect components in a fluid system. Fluid couplings may include a first coupling member that is attached to a first fluid component in the system and a second coupling member that is attached to a second fluid component of the system. The first and second coupling members of the fluid coupling may be connected to establish a fluid connection between the first and second fluid components and may be disconnected to terminate the fluid connection.

Many fluid couplings use a quick connect locking sleeve and locking balls to lock the coupling members together when they are assembled and to unlock the coupling members to allow disconnection. The locking sleeve in these couplings may be spring biased to a locked position to hold the locking balls in a position to lock the coupling members together. The locking sleeve may be retracted against the spring bias to an unlocked position to allow retraction of the locking balls and disconnection. Additionally, fluid couplings of this type may include valves that close to prevent leakage when the coupling members are disconnected and may include a fluid filter. Fluid couplings of this type facilitate connection and disconnection of the coupling members without tools.

### SUMMARY OF THE INVENTION

The present invention provides a fluid coupling for a fluid system. The coupling includes first and second coupling members. One of the coupling members may include a seal portion, and locking segments on the other coupling member are radially spaced from the seal portion during a connection and disconnection sequence to eliminate seal damage during the sequence. A seal blow out prevention surface retains the seal during disconnection. The fluid coupling may include a valve mechanism and a fluid filter, and the valve mechanism may be retained by the fluid filter or by a press fit within the coupling. The valve mechanism may include a self-aligning valve poppet. The coupling member may also include tamper resistant assembly surfaces.

The invention further provides various ones of the features and structures and methods described in the detailed description and in the claims set out below, alone and in combination, and the claims are incorporated by reference in this summary of the invention.

### BRIEF DESCRIPTION OF THE DRAWINGS

Embodiments of this invention are described in further detail below with reference to the accompanying drawings, in which:

FIG. 1 is a longitudinal cross sectional view of a fluid coupling according to a preferred embodiment of this invention, with the coupling members in a first partially connected or partially disconnected configuration;

FIG. 2 is a longitudinal cross sectional view of the fluid coupling shown in FIG. 1, with the coupling members in a second partially connected or partially disconnected configuration;

FIG. 3 is a longitudinal cross sectional view of the fluid coupling shown in FIG. 1, with the coupling members in a third partially connected or partially disconnected configuration;

FIG. 4 is a longitudinal cross sectional view of the fluid coupling shown in FIG. 1, with the coupling members in a fourth partially connected or partially disconnected configuration;

FIG. 5 is a longitudinal cross sectional view of the fluid coupling shown in FIG. 1, with the coupling members in a fifth or fully connected configuration;

FIG. 6 is a longitudinal cross sectional view of one of the coupling members of the coupling shown in FIG. 1, with an additional valve illustrated; and;

FIGS. 7a, 7b and 7c are diagrammatic illustrations of the wrench flat or gripping portion of one of the coupling members of the coupling shown in FIG. 1.

### DETAILED DESCRIPTION OF THE INVENTION

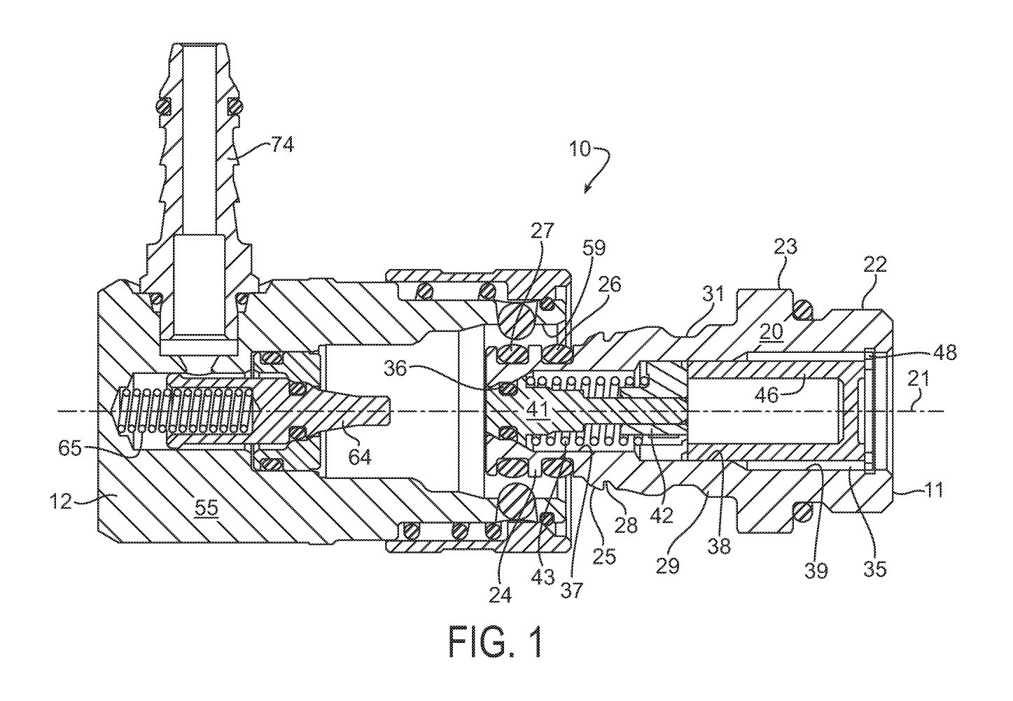

Referring now to the drawings in greater detail, FIGS. 1 through 7 illustrate a presently preferred embodiment of a fluid coupling 10 having a first coupling member 11 and a second coupling member 12. Fluid flow through the coupling 10 in the preferred embodiment is for most uses from the first coupling member 11 to the second coupling member 12. In one exemplary application for the coupling 10, the first coupling member 11 is attached to a component (not shown) of a system (not shown) and is used to connect and disconnect that component from other components (not shown) of the system. For example, the first coupling member 11 in the preferred embodiment may be attached on its right or inlet side as viewed in the drawings to a fluid component. In the preferred embodiment, the right or inlet side of the first coupling member 11 may be attached to a canister that generates a gas, such as ammonia, that is dispensed into a fossil fuel diesel engine exhaust system. In this application, the left or outlet side of the second coupling member 12 is connected to another fluid component, such as a fluid connector that carries the fluid to a component such as a diesel engine exhaust member (not shown). In this application, the coupling 10 may be used to connect and disconnect the above described ammonia gas canister to and from the above described diesel engine exhaust. Flow direction through the coupling 10 may be reversed, for example when the canister is being refilled. When the coupling members 11 and 12 are disconnected, the left end of the coupling member 11 is preferably provided with a sealing cap, as more fully disclosed in the co-pending international patent application titled “Sealing Cap” filed on the filing date of the present patent application and assigned to the same assignee as the present patent application. That co-pending patent application claims priority of U.S. Provisional Patent Application Ser. No. 61/508,760 filed on Jul. 18, 2011 and the disclosure of that co-pending patent application and the disclosure of U.S. Provisional Application No. 61/508,760 are incorporated herein by reference in their entireties.

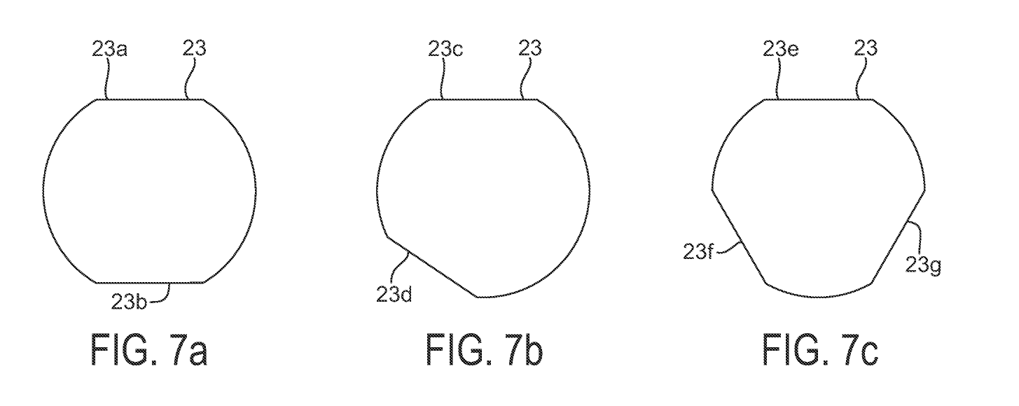

As shown in FIG. 1, the first coupling member 11 includes a hollow, generally cylindrical metal body or housing 20, preferably formed of a ferrous material such as American Society for Testing and Materials (ASTM) 303 stainless steel material. The body 20 has a longitudinal axis 21. The exterior of the body 20 includes an externally threaded end portion 22, a wrench flat gripping portion 23, a nominal diameter generally cylindrical coupling sealing portion 24, and a generally conical ramp portion 25. The wrench flat gripping portion 23 of the exterior of the body 20 is schematically illustrated in FIG. 7, which illustrates alternative configurations of the exterior surface of the gripping portion 23 in a plane perpendicular to the axis 21. In FIG. 7a, the exterior surface of the wrench flat gripping portion 23 is generally cylindrical and includes radially opposite wrench flats 23a and 23b which may be gripped by a conventional open end wrench to assist in assembling the first coupling member 11 onto its associated fluid component. Alternatively, the exterior surface of the wrench flat gripping portion 23 may be generally cylindrical as illustrated in FIG. 7b, with wrench flats 23c and 23d that are radially misaligned relative to one another. Additionally, the exterior surface of the wrench flat gripping portion 23 may be generally cylindrical as illustrated in FIG. 7c, with wrench flats 23e, 23f and 23g that are also radially misaligned relative to one another. In this manner, the exterior surface of the wrench flat gripping portion 23 that is radially opposite each wrench flat is not flat or is not substantially parallel to the wrench flat. A conventional open end wrench will not grip the alternative wrench flats illustrated in FIGS. 7b and 7c, to minimize disassembly of the first coupling member 11 by an operator or installer who has not been trained and provided with a special tool that grips the offset wrench flats illustrated in FIGS. 7b and 7c. The externally threaded end portion 22 is threadably connected to a mating threaded portion (not shown) of a fluid system component (not shown), such as for example the ammonia gas canister described above, using the wrench flats described above.

The coupling sealing portion 24 of the first coupling member 11 is received within the second coupling member 12 when the coupling member 11 is connected to the mating second coupling member 12, to establish a fluid connection between the fluid component to which the first coupling member 11 is attached and the fluid component to which the mating second coupling member 12 is attached. A spring loaded internal valve mechanism described further below closes the interior of the coupling member 11 when the coupling member 11 is disconnected from the mating second coupling member 12 and when the coupling member 11 is in partially connected configurations shown in FIGS. 1-3, as more fully discussed below. The coupling sealing portion 24 carries and includes two annular elastomeric O-rings 26 and 27, each of which is secured in an O-ring groove on the exterior surface of the mating sealing portion 24. The ramp 25 connects the sealing portion 24 a larger diameter generally cylindrical locking portion 29 of the coupling body 20 which includes an exterior locking surface. An annular locking clip groove 28 is provided to lock a sealing cap (not shown) on the coupling member 11 when the coupling members are disconnected, as further shown in the above referenced co-pending patent application. The outside diameter of the outermost edges of the locking clip groove 28 is greater than the outside diameter of the O-rings 26 and 27 and is greater than the diameter of a sealing surface of the second coupling member 12, as further described below.

Still referring to FIG. 1, the larger diameter generally cylindrical locking portion 29 of the first coupling member 11 on its outer locking surface further includes an annular ball locking groove 31, and the ramp portion 25 extends axially from the sealing portion 24 to the ball locking groove 31. The locking clip groove 28 is longitudinally intermediate the locking groove 31 and the sealing portion 24. The locking portion 29 and locking groove 31 and locking clip groove 28 each have a diameter greater than the diameter of the sealing portion 24 and elastomeric seals 26 and 27. The ramp portion 25 includes a radially outermost crest portion adjacent the locking portion 29.

The hollow generally cylindrical metal body 20 includes a passage or bore 35 extending longitudinally from end to end through the body 20. The above mentioned internal valve mechanism of the first coupling member 11 includes an O-ring seating surface or annular valve seat 36 at the left end of the first coupling member 11. First, second and third progressively enlarged diameter stepped bores 37, 38 and 39 extend from the O-ring seating surface 36 to the right end of the coupling member 11 as viewed in the drawings.

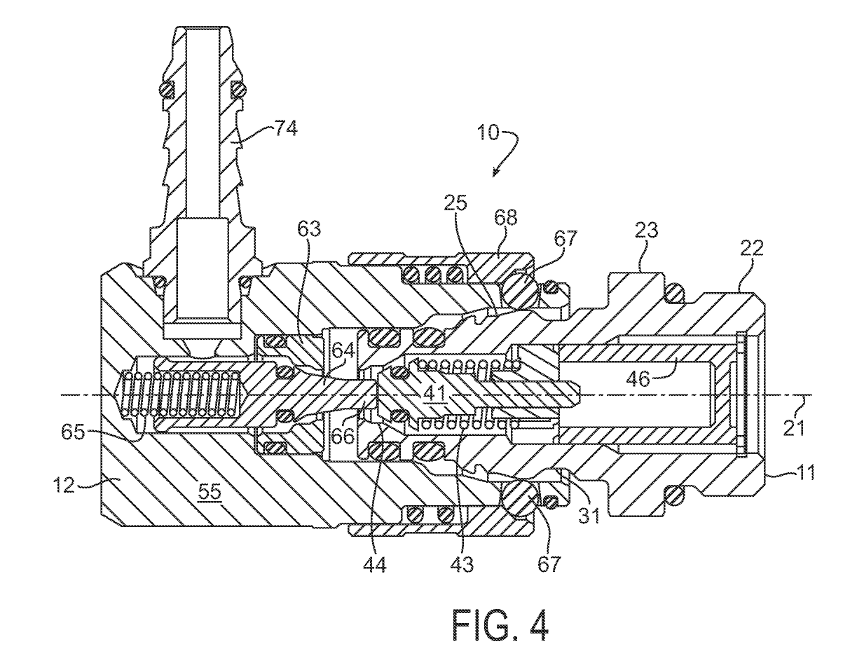

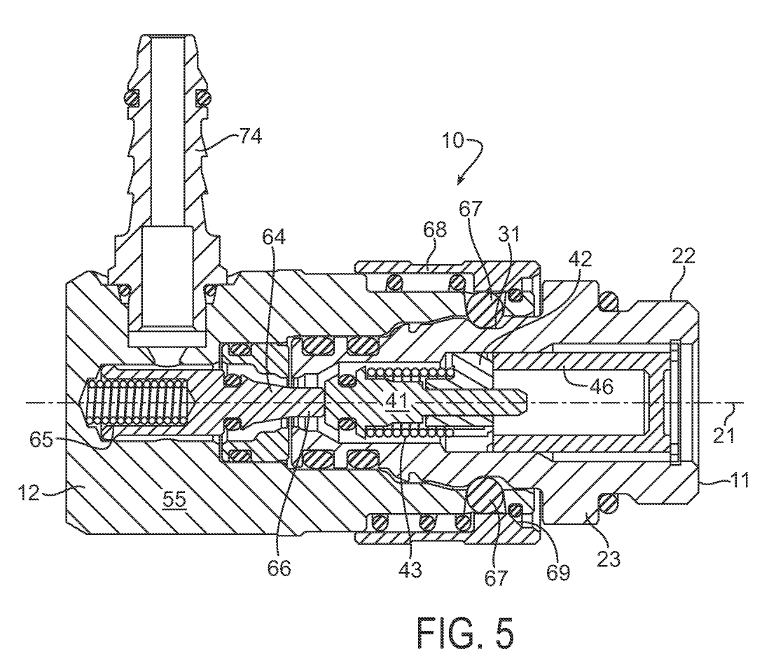

The first coupling member 11 further includes a valve poppet 41 that carries an O-ring seal on its left end that selectively engages and disengages the O-ring seating surface or valve seat 36 to open and close fluid flow through the coupling member 11 as further described below. The valve poppet 41 is slidably arranged in the first stepped bore 37 and is slidably carried by an annular valve guide 42 which is secured in the second stepped bore 38. A spring 43 acts between the valve guide 42 and the valve poppet 41 to bias the valve poppet to the left to its closed position shown in FIGS. 1-3 against valve seat 36. A porous powdered metal fluid filter 46 includes a hollow generally cylindrical portion that is closed at its inlet end by a disk shaped end. The porous powdered metal fluid filter 46 is in substantial axial alignment with the valve poppet 41. The filter 46 is preferably press fit in the second stepped bore 38 and retains the valve guide 42 and valve poppet in the positions shown in the drawings. The fluid filter 46 is upstream of the valve poppet 41 and valve guide 42, to filter contaminants from the fluid as it flows from the above described canister before the fluid reaches the valve poppet 41 and valve guide 42. The valve guide 42 may alternatively or additionally be press fit in the second stepped bore 38 for retention or retention back up purposes, and an annular snap ring 48 may be disposed in the right end of the third stepped bore 39 as a back up to hold the filter 46 and valve mechanism in place in the hollow body 20. As further described below, the valve poppet 41 is movable between a closed position (FIGS. 1-3), a partially opened position (FIG. 4) and a fully opened position (FIG. 5).

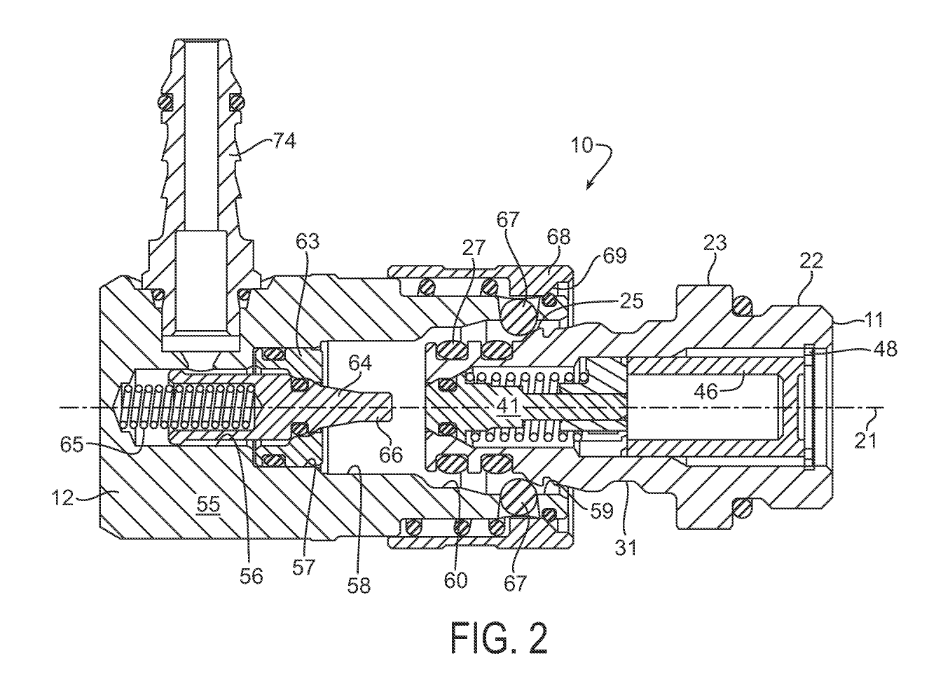

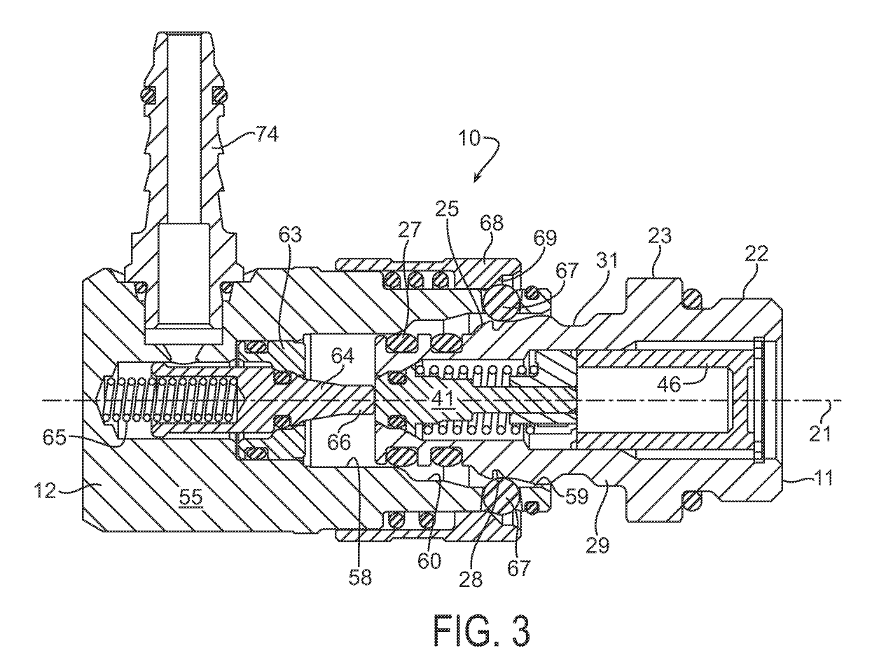

Referring now to FIG. 2, the second coupling member 12 includes a generally cylindrical body or housing 55 preferably formed of a ferrous material such as ASTM 303 stainless steel material. The body 55 is coaxial with the axis 21 of the first coupling member 11 in all of the configurations shown in the drawings. A stepped blind bore extends from the right end of the body 55 and includes progressively enlarged first, second, third and fourth stepped bores 56, 57, 58 and 59. The stepped bore 58 provides a generally cylindrical sealing portion or sealing surface for the second coupling member 12. A seal retention or blow out prevention surface 60 is provided intermediate the stepped bores 58 and 59. The blow out prevention surface is preferably generally cylindrical, but may be conical or of other geometric shape. The radius of the portion of the surface 60 that is radially aligned with the seal 27 during this movement from FIG. 3 to FIG. 2 when the seal 27 disengages from the bore 58 is no greater than and is preferably less than the sum of the radius of the bore 58 plus the radial thickness of the O-ring 27, as further discussed below. The term radially aligned or radial alignment to describe the relative positions of components means that the components are generally disposed along a common radial line or in a common plane that is substantially perpendicular to the longitudinal axis.

A valve seat 63 is press fit in the second bore portion 57, and a valve poppet 64 is biased by a spring 65 to a closed position shown in FIGS. 1-3. The preloads and spring rates of the springs 43 and 65 are preferably selected so that the spring 43 is slightly stronger than the spring 65 in the preferred embodiment, so that the valve poppet 64 opens slightly before the poppet 41 opens, as further discussed below. The valve poppet 64 includes a smaller diameter external peripheral surface portion that slides in the first stepped bore 56 and that provides a flow path for fluid when the coupling members 11 and 12 are in a fully connected position shown in FIG. 5 and further discussed below. The valve poppet 64 also includes an elastomeric O-ring seal that provides a valve poppet surface which engages a valve seat surface of the valve seat 63 to close the valve mechanism in the second coupling member 12 when the coupling members 11 and 12 are in their first, second and third partially connected positions shown in FIGS. 1-3. The valve poppet 64 further includes a longitudinally extending nose guide portion 66 which extends rightward through the valve seat 63 toward the first coupling member 11. The nose guide portion 66 cooperates with an annular rib on the left most end of the valve poppet 64 to provide a valve poppet guide as the coupling members are sequenced toward and away from their fully connected positions shown in FIG. 5, as more fully discussed below.

As further shown in FIG. 2, the fourth stepped bore 59 provides a locking portion or locking surface of the coupling member 12 and includes eight identical and circumferentially equally spaced tapered radial openings or holes, two of which are shown in the drawings. Spherical locking segments 67, two of which are shown in the drawings, are preferably locking balls that are arranged in each of the holes and project radially into the fourth stepped bore and radially outwardly to the exterior surface of the body 55. A spring biased locking sleeve 68 covers the balls 67 to hold them in a radially inward position when the coupling members 11 and 12 are in the configurations shown in FIGS. 1, 2 and 5. The locking sleeve 68 includes an annular holding ramp portion 69, and the holding portion 69 is radially aligned with the balls 68 when the coupling members 11 and 12 are in the position shown in FIG. 4, as explained further below.

Still referring to FIG. 2, the bore 56-59 is a blind bore that extends from an open interface end of the bore at the fourth bore portion 59 to the smaller diameter bore portion 56 at the blind end of the bore. The poppet 64 is slidably disposed in the smaller diameter bore portion 56. The valve seat 63 has a generally cylindrical exterior surface, and the exterior surface of the valve seat 63 is pressed into the bore portion 57 from the interface end with an interference fit to retain both the valve seat 63 and the poppet in the blind bore. This permits assembly of the poppet 64 and valve seat 63 from the open interface end of the bore 56-59.

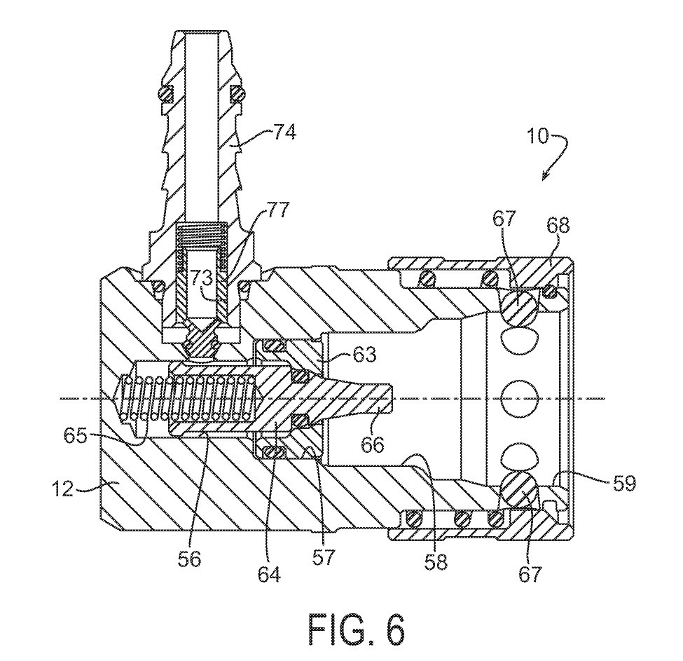

As shown in FIG. 6, an additional valve is preferably utilized in the coupling member 12. A threaded radial bore 73 extends radially from the exterior surface of the body 55 and intersects the first stepped bore 56. A fluid fitting 74 is threaded into the radial bore 73, and the exterior surface of the fluid fitting 74 that projects from the body 55 is arranged to receive the internal surface of an elastomeric tube or hose (not shown) to connect the second coupling member 12 to the above mentioned fluid component. A generally cylindrical shuttle poppet 77 is arranged between the fluid fitting 74 and a reduced diameter valve seat of the bore 73 adjacent the location at which the bore 73 opens to the bore 56. A spring carried by the fitting 74 biases the shuttle poppet 77 against the reduced diameter valve seat portion of the bore 73, to close the bore 73 and prevent back flow through the coupling 10 when the coupling members 11 and 12 are in a fully connected position shown in FIG. 5 and the valve poppets 41 and 64 are opened. To permit fluid flow through the coupling 10 from the coupling member 11 through the coupling member 12 when the coupling members 11 and 12 are in the fully connected position, positive fluid pressure in the bore 56 moves the shuttle poppet 77 away from the reduced diameter vale seat portion of the bore 73.

The connection sequence for the coupling members 11 and 12, and the positions or configurations of the components of the coupling members 11 and 12 during the connection sequence, are illustrated in FIGS. 1-5. FIG. 1 shows a first partially connected configuration, in which the coupling members 11 and 12 are coaxially disposed along the longitudinal axis 21 and the valve poppets 41 and 64 are closed. In this configuration, the sealing portion 24 and O-rings 26 and 27 are moved into the fourth stepped bore 59 or locking portion of the body 55. The seal 27 and balls 67 are substantially in radial alignment, and the radially innermost point of each of the locking balls define a locking diameter. The locking diameter is substantially equal to or greater than the external or outside diameter of the O-rings 26 and 27, so that the balls 67 do not substantially engage or damage the O-rings 26 and 27 during connection and disconnection. In this first partially connected configuration, the valve poppets 41 and 64 are held in their closed positions shown in FIG. 1 by their respective poppet springs 43 and 65.

The coupling member 11 during the connection sequence continues to move leftward as viewed in FIG. 1, until the ramp portion 25 of the coupling member 11 approaches or engages the locking balls 67 and the coupling members 11 and 12 reach a second partially connected configuration shown in FIG. 2. In this configuration, the locking balls 67 are in their radially inward positions. The above mentioned locking diameter, which is also the radial distance between radially opposite locking balls 67 in their radially inward positions, is substantially less than the diameter of the ramp portion 25 adjacent the locking balls 67. In this second partially connected configuration, the valve poppets 41 and 64 continue to be held in their closed positions shown in FIG. 2 by their respective poppet springs, and the ramp 25 and locking balls 67 are substantially in radial alignment.

The locking sleeve 68 is moved to the left from its locked position shown in FIGS. 1 and 2 to an unlocked position as shown in FIG. 3 by the installer, to allow the coupling sequence to progress to the third partially connected configuration shown in FIG. 3. During this sequence, the balls 67 move radially outward along the ramp portion 25 until the balls 67 are substantially in radial alignment with the locking sleeve holding portion 69. The locking balls in this third configuration shown in FIG. 3 hold the locking sleeve 68 in its unlocked position when the locking sleeve 68 is released by the installer. In this configuration, the locking balls 67 may also be substantially in radial alignment with the clip locking groove 28. In this third partially connected configuration, the valve poppets 41 and 64 engage but continue to be held in their closed positions shown in FIG. 3 by their respective poppet springs 43 and 65. The sealing portion 24 of the first coupling member 11 is substantially in radial alignment with the sealing portion 58 of the second coupling member 12, so that the elastomeric seal 27 engages and seals against the sealing portion 58 to prevent leakage as the coupling members 11 and 12 continue their connection sequence.

As the coupling member 11 continues to move leftward relative to the coupling member 12 to the fourth partially connected configuration shown in FIG. 4, the locking balls 67 continue to move radially outward along the ramp portion 25 until the balls 67 are substantially in radial alignment with the radially outermost or largest diameter crest portion of the ramp portion 25. In this fourth configuration, the locking balls 67 are in their radially outermost position and continue to hold the locking sleeve 68 in its unlocked position shown in FIG. 4. In this fourth partially connected configuration, the valve poppets 41 and 64 engage and act against one another to move the other to a partially opened position shown in FIG. 4 against the bias of their poppet springs. During movement of the valve poppets 41 and 64, the longitudinally extending nose portion 66 of the valve poppet 64 extends through the valve seat 63 and through the valve seat 44 to maintain radial alignment of the poppets 41 and 64 in their respective stepped bores and to prevent misalignment of the poppets 41 and 64 from their longitudinal axis 21. The sealing portions 24 and 58 continue to be substantially radially aligned, so that leakage is prevented as the valve poppets 41 and 64 open.

As the connection sequence continues, the coupling member 11 next moves further leftward relative to the coupling member 12 to the fifth or fully coupled configuration shown in FIG. 5. In the fully coupled configuration shown in FIG. 5, the locking balls 67 of the second coupling member 12 are substantially radially aligned with the locking groove 31 of the first coupling member 11. The locking balls 67 are pushed radially inward from the position shown in FIG. 4 to the locked position shown in FIG. 5 by the holding portion 69 of the locking sleeve 68. The spring acting against the locking sleeve 68 moves the locking sleeve 68 to its locked position shown in FIG. 5, in which the locking sleeve 68 locks the balls 67 in their radially inward position in the locking groove 31 to lock the coupling members 11 and 12 together. In this fifth or fully connected configuration, the valve poppets 41 and 64 engage and act against one another to move the valve poppets 41 and 64 to a fully opened position shown in FIG. 5 against the bias of their poppet springs. The valve poppet 41 in this position bottoms out against the valve guide 42 and/or the valve poppet 64 bottoms out against the left end of the first stepped bore 56, so that each valve poppet holds the other in its fully opened positions shown in FIG. 5.

To disconnect the coupling members 11 and 12 from the fully connected configuration shown in FIG. 5, the above described sequence is reversed. During disconnection, the locking sleeve 68 is moved longitudinally from its fully connected position shown in FIG. 5 to the position shown in FIG. 4. The first coupling member 11 begins to move rightward relative to the second coupling member 12, and the valve poppets 41 and 64 partially close. During this closing movement of the valve poppets 41 and 64, the extended nose guide portion 66 extends through both valve seats 44 and 63 as the coupling members 11 and 12 move back to their fourth partially connected position shown in FIG. 4. The valve poppets 41 and 64 partially close, and the balls 67 move radially outward from the locking groove 31 as shown in FIG. 4. The balls 67 are then radially aligned with the ramp surface 69 of the sleeve 68, and the operator can release the sleeve 68 during further disconnection movement from the fourth configuration illustrated in FIG. 4 through the third and second configurations and back to the first configuration illustrated in FIG. 1. The locking balls during this continued disconnection movement move down the ramp 25 to their radially inward positions shown in FIGS. 2 and 1. The valve poppets 41 and 64 close by action of their respective springs 43 and 65, and the sealing portions 24 and 58 continue to seal against leakage until the valve poppets 41 and 64 are closed as illustrated in FIG. 3.

As the disconnection of the coupling members 11 and 12 continues from the third configuration illustrated in FIG. 3 to the second configuration illustrated in FIG. 2, the O-ring seal 27 disengages from the bore 58 and moves into radial alignment with the blow out prevention surface 60. If residual pressure is present in the bore 58 during this movement, the residual pressure and resultant flow will tend to lift the O-ring seal 27 out of its associated groove. When this occurs, the radially outward movement of the O-ring seal 27 is limited by the surface 60, so that the O-ring 27 cannot move fully out of its associated groove. This prevents blow out of the O-ring 27 during disconnection movement from the FIG. 3 configuration to the FIG. 2 configuration as residual pressure in the bore 58 escapes between the O-ring 27 and the blow out prevention surface 60. When the coupling members 11 and 12 reach the first partially connected position shown in FIG. 1, the coupling members 11 and 12 may be fully disconnected and removed from one another.

Presently preferred embodiments of the invention are shown in the drawings and described in detail above. The invention is not, however, limited to these specific embodiments. Various changes and modifications can be made to this invention without departing from its teachings, and the scope of this invention is defined by the claims set out below.

1. A fluid coupling comprising a first coupling member, a second coupling member, the coupling members having partially connected configurations and a fully connected configuration,
the coupling members each having a bore with a longitudinal axis, a sealing portion, and a locking portion, the longitudinal axes being coaxial,
the first coupling member sealing portion including a generally cylindrical exterior sealing surface, the first coupling member locking portion including an exterior locking surface,
the second coupling member sealing portion including a generally cylindrical interior sealing surface, the second coupling member locking portion including an interior locking surface, a plurality of radial openings extending into the interior locking surface, locking segments located in the openings and extending into the interior locking surface,
the locking segments having a radially outer unlocked configuration when the coupling members are in at least one of their partially connected configurations, the locking segments having a radially inward fully locked position when the coupling members are in their fully connected configuration in which the radially innermost point of the locking segments define a locking diameter, and the locking diameter of the locking segments being substantially equal to or greater than the diameter of the first coupling member exterior sealing surface.

2. A fluid coupling as set forth in claim 1, wherein the first coupling member sealing surface includes a radially outwardly facing annular elastomeric seal, the elastomeric seal has an external diameter when the coupling members are in at least one of their partially connected configurations, and the locking diameter of the locking segments is substantially equal to or greater than the external diameter of the elastomeric seal.

3. A fluid coupling member as set forth in claim 2, wherein the first coupling member locking portion includes an exterior locking surface and an annular exterior locking groove in the locking surface, the first coupling member has an exterior ramp portion extending between its sealing surface and its locking surface, and the locking segments extend into the locking groove when the coupling members are in the fully coupled configuration.

4. A fluid coupling member as set forth in claim 3, wherein the first coupling member includes a locking clip groove, the locking clip groove is longitudinally intermediate the first coupling member locking groove and the first coupling member sealing surface, and the locking clip groove has a diameter greater than the external diameter of the elastomeric seal.

5. A fluid coupling as set forth in claim 4, wherein the locking segments are substantially in radial alignment with the locking clip groove when the coupling members are in one of their partially connected configurations.

6. A fluid coupling as set forth in claim 2, wherein the first coupling member sealing portion engages the second coupling member sealing surface when the coupling members are in their fully connected position.

7. A fluid coupling as set forth in claim 6, wherein the first coupling member has an exterior ramp portion extending between its sealing surface and its locking surface, the first coupling member and the second coupling member each include a valve poppet having a closed position and an opened position, and the first coupling member sealing surface engaging the second coupling member sealing surface when the first and second coupling members are in the fully connected configuration and when the first and second coupling members are in all partially connected configurations in which one or both of the valve poppets are in an opened position.

8. A fluid coupling as set forth in claim 1, wherein the partially connected configurations include one partially connected configuration and another partially connected configuration, the first coupling member sealing portion includes an annular seal groove in the exterior sealing surface, an annular exterior elastomeric seal in the seal groove,
the second coupling member includes an interior seal retention surface intermediate the interior sealing surface and the interior locking surface, the seal retention surface has an internal radius greater than the radius of the internal sealing surface and less than the sum of the radius of the exterior sealing surface plus the radial thickness of the elastomeric seal,
the locking segments and elastomeric seal are substantially radially aligned and are substantially radially spaced apart when the coupling members are in the one partially connected configuration,
and the elastomeric seal and the seal retention surface are radially aligned when the coupling members are in the other partially connected configuration.

9. A fluid coupling as set forth in claim 3, wherein the partially connected configurations include first and second partially connected configurations, the locking segments and elastomeric seal are substantially radially aligned and are substantially radially spaced apart when the coupling members are in the first partially connected configuration, and the locking segments and ramp portion are substantially radially aligned when the coupling members are in the second partially connected configuration.

10. A fluid coupling as set forth in claim 3, wherein the locking segments are locking balls, the partially connected configurations include first, second and third partially connected configurations, the locking balls and elastomeric seal are substantially radially aligned and are substantially radially spaced apart when the coupling members are in the first partially connected configuration, the locking balls and ramp portion are substantially radially aligned when the coupling members are in the second partially connected configuration, the second coupling member includes a locking sleeve external of the locking balls, the locking sleeve has a holding ramp, and the locking balls and ramp portion and holding ramp are substantially radially aligned when the coupling members are in the third partially connected configuration.

11. A fluid coupling as set forth in claim 3, wherein the locking segments are locking balls, the partially connected configurations include first, second, third and fourth partially connected configurations, the locking balls and elastomeric seal are substantially radially aligned and are substantially radially spaced apart when the coupling members are in the first partially connected configuration, the locking balls and ramp portion are substantially radially aligned when the coupling members are in the second partially connected configuration, the second coupling member includes a locking sleeve external of the locking balls, the locking sleeve has a holding ramp, the locking balls and ramp portion and holding ramp are substantially radially aligned when the coupling members are in the third partially connected configuration, the ramp portion has a radially outermost annular crest portion, the locking balls are substantially radially aligned with the crest portion when the coupling members are in the fourth partially connected configuration, and the sealing portion of the first coupling member engages the sealing surface of the second coupling member when the coupling members are in the fourth partially connected configuration.

12. A coupling member as set forth in claim 1, wherein the first coupling member includes a fluid valve mechanism and a fluid filter disposed in the first coupling member bore, and the fluid filter engages the fluid valve mechanism and secures the fluid valve mechanism in the bore.

13. A fluid coupling as set forth in claim 12, wherein the first coupling member includes a retaining ring in its bore, and the retaining ring retains the fluid filter in the bore.

14. A fluid coupling as set forth in claim 1, wherein the first coupling member includes an exterior gripping portion, the exterior gripping portion includes at least one wrench flat, and the portion of the exterior gripping portion radially opposite the wrench flat on the exterior gripping portion is substantially non-parallel to the wrench flat.

15. A fluid coupling as set forth in claim 1, wherein each of the coupling members include a valve seat and a valve poppet, one of the valve poppets includes a longitudinally projecting alignment nose portion, and the nose portion extends longitudinally through both of the valve seats when the coupling members are in their fully connected configuration.

16. A fluid coupling member comprising a housing, a bore extending longitudinally through the housing and having a longitudinal axis, a fluid valve mechanism disposed in the bore, a fluid filter disposed in the bore, and the fluid filter engaging the fluid valve mechanism and securing the fluid valve mechanism in the bore.

17. A fluid coupling member as set forth in claim 16, wherein the fluid valve mechanism and the fluid filter each have a longitudinal axis, and the longitudinal axes of the bore and fluid valve mechanism and fluid filter are coaxial.

18. A fluid coupling member as set forth in claim 17, wherein the bore is a stepped bore having a smaller diameter portion and a larger diameter portion, the fluid valve mechanism is disposed substantially within the smaller diameter portion, and the fluid filter is disposed substantially within the larger diameter portion.

19. A fluid coupling member as set forth in claim 18, wherein the fluid filter is press fit within the larger diameter portion.

20. A fluid coupling as set forth in claim 19, wherein the coupling member includes a retaining ring in the bore, and the retaining ring retains the fluid filter in the bore.

21. A fluid coupling comprising a first coupling member, a second coupling member, the coupling members having a fully connected position and partially connected configurations,
the coupling members each having a longitudinal axis, a sealing portion disposed along each of the longitudinal axes, the longitudinal axes being coaxial,
the first coupling member sealing portion including a generally cylindrical exterior surface, an annular seal groove in the exterior surface, an annular exterior elastomeric seal in the seal groove,
the second coupling member sealing portion including a generally cylindrical interior sealing surface, the second coupling member including an interior seal retention surface substantially adjacent the interior sealing surface, the seal retention surface having an internal radius greater than the radius of the internal sealing surface and less than the sum of the radius of the exterior surface plus the radial thickness of the elastomeric seal,
each of the coupling members having a valve mechanism along its longitudinal axis, the valve mechanisms each having an opened configuration and a closed configuration,
the interior sealing surface and the elastomeric seal being radially aligned and the valve mechanisms being opened when the coupling members are in their fully connected position,
and the interior seal retention surface and the elastomeric seal being radially aligned and the valve mechanisms being closed when the coupling members are in one of their partially connected configurations.

22. A fluid coupling as set forth in claim 21, wherein each of the coupling members includes a locking surface, the locking surfaces are movable between a locked position securing the locking surfaces together and an unlocked position releasing the locking surfaces from one another, the locking surfaces being in the unlocked position when the coupling members are in their partially connected configurations, the locking surfaces being in the locked position when the coupling members are in their fully connected configurations, and the locking surfaces of the second coupling member being on a side of the seal retention surface longitudinally opposite the side of the seal retention surface that is substantially adjacent the interior sealing surface.

23. A fluid coupling member comprising a housing, a bore extending longitudinally through the housing and having a longitudinal axis, an exterior threaded end portion on the exterior of the housing, an exterior gripping portion on the exterior of the housing, the exterior gripping portion including at least one wrench flat, and the portion of the exterior gripping portion radially opposite the wrench flat is substantially non-parallel with the wrench flat.

24. A fluid coupling member as set forth in claim 23, wherein the number of wrench flats is two, and all of the wrench flats on the exterior of the housing are radially misaligned with one another.

25. A fluid coupling member as set forth in claim 24, wherein the number of wrench flats is three, and all of the wrench flats on the exterior of the housing are radially misaligned with one another.

26. A fluid coupling comprising a first coupling member, a second coupling member, the coupling members having partially connected configurations and a fully connected configuration, the coupling members each having a bore with a longitudinal axis, a valve mechanism disposed in each of the bores, each of the valve mechanisms including a valve poppet and a valve seat, one of the valve poppets including a longitudinally projecting alignment nose portion, and the nose portion extending longitudinally through both of the valve seats when the coupling members are in their fully connected configuration.

27. A fluid coupling as set forth in claim 26, wherein the nose portion extends longitudinally through both of the valve seats when the coupling members are in at least one of their partially connected configuration.

28. A fluid coupling as set forth in claim 26, wherein the bore in each coupling member is a stepped bore having a smaller diameter portion and a larger diameter portion, each of the valve poppets is retained in a smaller diameter portion of the bore of its associated coupling member, and the valve poppets engage one another.

29. A fluid coupling as set forth in claim 26, wherein each of the coupling members includes a spring acting against the valve poppet of its associated coupling member, and engagement of the valve poppets causes each of the valve poppets to move the other valve poppet during connection and disconnection of the coupling members.

30. A fluid coupling member comprising a housing, a bore in the housing having a longitudinal axis and a longitudinally open interface end, an annular valve seat disposed in the bore and having an annular valve seat surface, a valve poppet disposed in the bore and having a valve poppet surface movable between an opened position spaced from the valve seat surface and a closed position engaging the valve seat surface, the annular valve seat being disposed in the bore between the valve poppet surface and the open interface end of the bore, the annular valve seat having an exterior surface radially outward of the valve seat surface and radially outward of the valve poppet surface, the exterior surface of the annular valve seat engaging the bore with an interference fit, and the annular valve seat retaining the valve poppet in the bore.

31. A fluid coupling member as set forth in claim 30, wherein the exterior surface of the valve seat is radially outward of the valve poppet surface.

32. A fluid coupling member as set forth in claim 30, wherein the bore is a stepped blind bore having a smaller diameter bore portion and a larger diameter bore portion, the larger diameter bore portion is longitudinally disposed between the open interface end and the smaller diameter bore portion, the valve poppet is slidably disposed in the smaller diameter bore portion, the valve seat is disposed in the larger diameter bore portion, and the valve seat exterior surface engages the larger diameter bore portion with an interference fit.

33. A fluid coupling member having partially connected configurations and a fully connected configuration,
the coupling member having a bore with a longitudinal axis, a sealing portion, and a locking portion,
the coupling member sealing portion including a generally cylindrical interior sealing surface, the coupling member locking portion including an interior locking surface, a plurality of radial openings extending into the interior locking surface, locking segments located in the openings and extending into the interior locking surface,
the locking segments having a radially outer unlocked configuration when the coupling member is in at least one of its partially connected configurations, the locking segments having a radially inward fully locked position when the coupling member is in its fully connected configuration in which the radially innermost point of the locking segments define a locking diameter, and the locking diameter of the locking segments being greater than the diameter of the interior sealing surface.

34. A fluid coupling member having partially connected configurations and a fully connected configuration,
the coupling member having a bore with a longitudinal axis, a sealing portion, and a locking portion,
the coupling member sealing portion including a generally cylindrical exterior sealing surface,
the coupling member locking portion including an exterior locking surface, an annular exterior locking groove in the locking surface, an exterior ramp portion extending between the sealing surface and the locking surface,
the exterior diameter of the exterior locking groove being greater than the exterior diameter of the exterior sealing surface.

35. A fluid coupling member as set forth in claim 34, wherein the coupling member sealing surface includes a radially outwardly facing annular elastomeric seal, the elastomeric seal has an external diameter when the coupling member is in at least one of its partially connected configurations, and the exterior diameter of the locking groove is greater than the external diameter of the elastomeric seal.

36. A fluid coupling member as set forth in claim 34, wherein the coupling member includes a locking clip groove, the locking clip groove is disposed along the ramp longitudinally intermediate the locking groove and the sealing surface, and the locking clip groove has a diameter greater than the external diameter of the exterior sealing surface.
